(19) United States
(12) Patent Application Publication
(10) Pub. No.: US 2025/0225702 A1
(43) Pub. Date: Jul. 10, 2025

(54) IMAGE PROCESSING METHOD, APPARATUS, ELECTRONIC DEVICE, AND STORAGE MEDIUM

(71) Applicant: Beijing Zitiao Network Technology Co., Ltd., Beijing (CN)

(72) Inventors: Mingwei Li, Beijing (CN); Long Chen, Beijing (CN); Zhong Chai, Beijing (CN); Nanjiang Xie, Beijing (CN); Jiajia Li, Beijing (CN); Yunhao Liao, Beijing (CN)

(21) Appl. No.: 19/013,319

(22) Filed: Jan. 8, 2025

(30) Foreign Application Priority Data
Jan. 10, 2024 (CN) 202410039457.7

(51) Int. Cl. G06T 11/60; G06T 5/50

(52) U.S. Cl. CPC G06T 11/60; G06T 5/50; G06T 2207/20221

(57) ABSTRACT

Embodiments of the present disclosure provide an image processing method, an apparatus, an electronic device, and a storage medium. The method comprises: determining retrieval information corresponding to at least one image to be used; obtaining a target parameter to be sent to a first serving end by processing text descriptive information of the image to be used and the retrieval information, to cause the first serving end to perform image processing based on the target parameter.

### CROSS-REFERENCE TO RELATED APPLICATION(S)

This application claims priority to Chinese Application No. 202410039457.7 filed on Jan. 10, 2024, the disclosures of which are incorporated herein by reference in their entireties.

### FIELD

Embodiments of the present disclosure relate to the field of image processing technology, and more specifically, to an image processing method, an apparatus, an electronic device, and a storage medium.

### SUMMARY

Embodiments of the present disclosure provide an image processing method, an apparatus, an electronic device, and a storage medium, to determine the parameters to be sent to the serving end based on the retrieval information and the image descriptive information corresponding to the image. The data transfer efficiency is thus improved.

In a first aspect, embodiments of the present disclosure provide an image processing method, comprising:
determining retrieval information corresponding to at least one image to be used;
obtaining a target parameter to be sent to a first serving end by processing text descriptive information of the image to be used and the retrieval information, to cause the first serving end to perform image processing based on the target parameter;
wherein the text descriptive information corresponds to image content of the image to be used.

In a second aspect, embodiments of the present disclosure provide an image processing apparatus, comprising:
a retrieval information determining module for determining retrieval information corresponding to at least one image to be used;
a target parameter determining module for obtaining a target parameter to be sent to a first serving end by processing text descriptive information of the image to be used and the retrieval information, to cause the first serving end to perform image processing based on the target parameter;
wherein the text descriptive information corresponds to image content of the image to be used.

In a third aspect, embodiments of the present disclosure also provide an electronic device, comprising:
one or more processors;
a storage apparatus for storing one or more programs;
the one or more programs, when executed by the one or more processors, causing the one or more processors to implement the image processing method according to any of the embodiments of the present disclosure.

In a fourth aspect, embodiments of the present disclosure further provide a storage medium containing computer-executable instructions, wherein the computer-executable instructions, when executed by a computer processor, perform the image processing method according to any of the embodiments of the present disclosure.

### BRIEF DESCRIPTION OF THE DRAWINGS

Through the following detailed description with reference to the accompanying drawings, the above and other objectives, features, and advantages of embodiments of the present disclosure will become more apparent. Throughout the drawings, same or similar reference signs indicate same or similar elements. It should be appreciated that the drawings are schematic and the original components and the elements are not necessarily drawn to scale.

FIG. 1 illustrates a schematic flowchart of an image processing method provided by embodiments of the present disclosure;

FIG. 2 illustrates a schematic flowchart of determination of the retrieval information provided by embodiments of the present disclosure;

FIG. 3 illustrates a schematic flowchart of another image processing method provided by embodiments of the present disclosure;

FIG. 4 illustrates a schematic flowchart of an image processing method provided by embodiments of the present disclosure;

FIG. 5 illustrates a schematic flowchart of a further image processing method provided by embodiments of the present disclosure

FIG. 6 illustrates a structural diagram of an image processing apparatus provided by embodiments of the present disclosure;

FIG. 7 illustrates a structural diagram of an electronic device provided by the embodiments of the present disclosure.

### DETAILED DESCRIPTION OF EMBODIMENTS

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

It should be appreciated that various steps disclosed in the method implementations of the present disclosure may be executed by different orders, and/or in parallel. Besides, the method implementations may include additional steps and/or omit the illustrated ones. The scope of the present disclosure is not restricted in this regard.

The term “includes” and its variants are to be read as open-ended terms that mean “includes, but is not limited to.” The term “based on” is to be read as “based at least in part on.” The term “one embodiment” is to be read as “at least one embodiment.” The term “a further embodiment” is to be read as “at least one further embodiment.” The term “some embodiments” is to be read as “at least some embodiments.” Definitions related to other terms will be provided in the following description.

It is noted that the terms “first”, “second” and so on mentioned in the present disclosure are provided only to distinguish different apparatuses, modules or units, rather than limiting the order of the functions executed by these apparatuses, modules or units or dependency among apparatuses, modules or units.

It is reminded here that the modifications including “one” and “more” in the present disclosure are schematic and non-restrictive. Those skilled in the art should understand that the above modifications are to be interpreted as “one or more” unless indicated otherwise in the context.

Names of messages or information exchanged between a plurality of apparatuses in the implementations of the present disclosure are provided only for explanatory purposes, rather than being restrictive.

It is to be appreciated that prior to the use of the technical solutions disclosed by various embodiments of the present disclosure, type, usage scope and application scenario of personal information involved in the present disclosure are made known to users through suitable ways according to the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, according to the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

It is to be understood that data (including but not limited to the data per se, acquisition or use of the data) involved in the technical solution should comply with corresponding laws and regulations.

At present, in case of effect processing of images, an original image to be processed is obtained and then encoded to obtain a data stream of the original image. Further, an image processing request is sent to a serving end in the form of data streams, to allow the serving end to perform effect processing on the original image based on the data streams.

However, during the effect processing, it is required to encode or decode every image at the client, which may occupy an excessively high portion of the internal memory for processing. Alternatively, if a plurality of original images is to be sent to the serving end simultaneously, a higher demand is proposed for the bandwidth of the serving end, which may lead to image transfer delay or image transfer failure.

Before the introduction of the technical solution, an example of the application scenario may be explained. The technical solution may be applied into any scenarios related to image processing. As an example, in case of effect processing of images, an original image to be processed is usually obtained and then encoded based on the client to obtain a data stream corresponding to the original image. Further, the data stream is transferred to the serving end, to allow the serving end to perform the effect processing on the original image based on the data stream. However, in case there are multiple original images to be processed, it is required to encode or decode every image at the client during the effect processing, which may occupy an excessively high portion of the internal memory for processing. Alternatively, if a plurality of original images is to be sent to the serving end simultaneously, a higher demand is proposed for the bandwidth of the serving end, which may lead to image transfer delay or image transfer failure.

At this point, on the basis of the technical solutions according to embodiments of the present disclosure, after the client determines the image to be processed, the image to be processed may be sent to a rendering end, to allow the rendering end to render the image to be processed. As a result, at least one image to be used corresponding to the image to be processed is obtained and stored locally. Besides, the text descriptive information corresponding to the image to be processed is determined based on the rendering end. Moreover, the retrieval information corresponding to the at least one image to be used may be determined based on the rendering end. Optionally, the retrieval information may be retrieval information. Afterwards, the retrieval information may be concatenated with the corresponding text descriptive information to obtain a target parameter in a target format. The target parameter may be sent to the serving end to allow the serving end to determine a target image corresponding to the image to be processed based on the target parameter. In such case, the parameter to be sent to the serving end is determined based on the retrieval information and the image descriptive information corresponding to the image. The data transfer efficiency is thus improved. Furthermore, the respective associated executive subjects are decoupled during the image processing, such that each executive subject has a more dedicated function. The image processing efficiency is therefore enhanced.

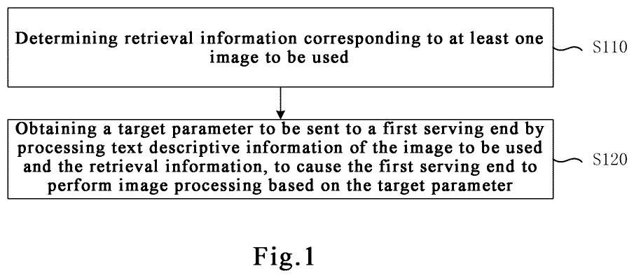

FIG. 1 illustrates a schematic flowchart of an image processing method provided by an embodiment of the present disclosure. Embodiments of the present disclosure are adapted to scenarios where an original image to be processed is obtained based on a client and a target image corresponding to the original image is determined based on a serving end. This method may be executed by an image processing apparatus, which apparatus may be implemented in the form of software and/or hardware. Optionally, the apparatus is implemented by an electronic device, and the electronic device may be a mobile terminal, a PC terminal or a server etc.

As shown in FIG. 1, the method according to this embodiment may specifically include:

S110: determining retrieval information corresponding to at least one image to be used.

It is to be explained that the technical solution provided by this embodiment of the present disclosure may be executed by a rendering end, wherein the rendering end may be understood as a program for performing a rendering procedure. It is to be appreciated that the rendering end may be a module integrated in a client, and also may be an interface integrated in the client, on which interface the rendering end is called. The embodiment of the present disclosure is not specifically restricted in this regard.

In this embodiment, the image to be used may be an image employed to obtain the final desired target image. The image to be used may be a raw original image and also may be an image obtained from processing the original image with an image processing algorithm. The embodiment of the present disclosure is not specifically restricted in this regard. Optionally, in case that the image to be used is a raw original image, the image to be used may be an image stored in a local storage space (e.g., local album) of the client; alternatively, the image to be used may also be an image collected based on a camera apparatus deployed in the client. Optionally, where the image to be processed is an image obtained from processing the original image with an image processing algorithm, the original image may be sent to an image rendering end based on the client. Further, the original image is processed at the image rendering end according to the image processing algorithm, to obtain a processed original image, where the processed original image is stored at the image rendering end. Moreover, a storage path of the processed original image is fed back to the client, to allow the client to read the processed original image based on the storage path. At this point, the processed original image may serve as the image to be used.

In this embodiment, the retrieval information may be understood as information for retrieving a corresponding image. The retrieval information may include any information capable of retrieving a corresponding image. Optionally, the retrieval information may include a uniform resource identifier of the image to be used, wherein the Uniform Resource Identifier (URI) is a character string for identifying a certain Internet resource position and/or name. Such identifier allows users to perform interactive operations on any resources through a particular protocol. It is to be appreciated that every resource available on the Internet, such as files, images, video clips and programs etc., may be located by one piece of retrieval information. In this embodiment, the retrieval information may be used for identifying image name and storage position of the image to be used and is identification for retrieving the image to be used.

In practical use, after at least one image to be used is determined at the rendering end, i.e., the retrieval information corresponding to respective images to be used may be determined based on the rendering end to facilitate subsequently obtaining the corresponding image to be used based on the retrieval information.

It is to be explained that the rendering end may upload the determined image to be used to the serving end for image processing, so as to obtain the retrieval information corresponding to the image to be used. Where there are at least two images to be used, the images to be used are usually uploaded in parallel to the serving end. In case of parallel upload, the network bandwidth is limited and it is possible that an image having a small footprint has an uploading speed greater than an image having a large footprint. Consequently, the uploading order of the images to be used is inconsistent with the receiving order.

On this basis, the at least one image to be used includes at least two images to be used, and determining the retrieval information corresponding to the at least one image to be used includes: uploading the at least two images to be used to a second serving end and recording an uploading order of the at least two images to be used; determining, based on the uploading order and a receiving order by which the second serving end receives the at least two images to be used, retrieval information corresponding to the at least two images to be used.

In this embodiment, the second serving end may be appreciated as a program for executing the image processing procedure. The second end may be a video cloud service, and also may be a local server, wherein the video cloud service may be a program that can execute the video cloud service. It is to be understood that the video cloud service is a video stream media service based on cloud computing technology. The processing and distribution of video contents may be provided to the users through cloud computing.

In this embodiment, the uploading order indicates an order of uploading the image to be used to the second serving end based on the rendering end. The receiving order may be an order by which the second serving end receives the image to be used.

In practical use, in case that the rendering end determines at least one image to be used and determines that the at least one image to be used includes at least two images to be used, the at least two images to be used may be uploaded to the second serving end based on the rendering end and the uploading order of the at least two images to be used is recorded. Meanwhile, the retrieval information of the at least two images to be used may also be recorded. Moreover, the receiving order by which the second serving end receives the at least two images to be used may be determined. An arrangement order of the retrieval information may be adjusted based on the receiving order, such that the adjusted arrangement order is consistent with the receiving order. Further, the retrieval information after the order adjustment may serve as the retrieval information of the image to be used, to facilitate the rendering end to continue executing subsequent operations based on the retrieval information. With such setting, it is ensured that the arrangement order of the retrieval information of the image to be used is consistent with the receiving order of the image to be used.

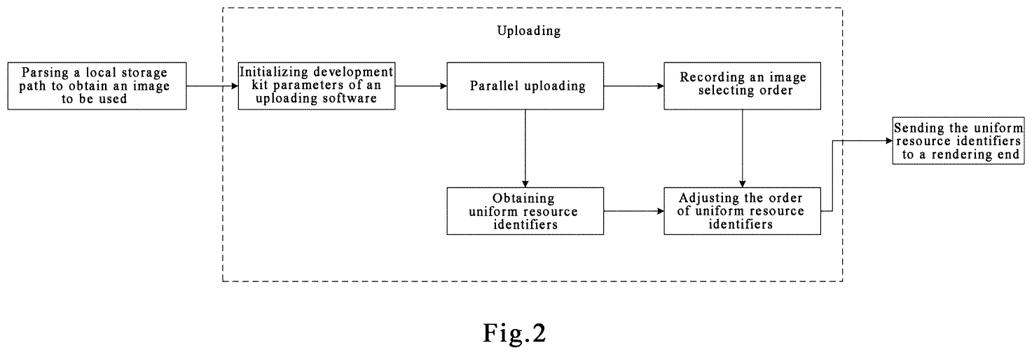

As an example, FIG. 2 illustrates a schematic flowchart of a procedure for determining the retrieval information. As shown, a local storage address sent by the rendering end is received based on the client and the image to be used is retrieved from the rendering end based on the local storage address. Furthermore, the image to be used is uploaded to the video cloud service based on the client according to an image selecting order. First, development kit parameters of an uploading software are initialized. Then, the image to be used is uploaded to the video cloud service to obtain the uniform resource identifier of the image to be used. The image selecting order may alter during the uploading procedure on account of the parallel upload. As such, the image selecting order may be recorded; after the uniform resource identifier of the image to be used is obtained, the order of the uniform resource identifier may be adjusted based on the image selecting order, and the adjusted uniform resource identifier is sent to the rendering end.

S120: obtaining a target parameter to be sent to a first serving end by processing text descriptive information of the image to be used and the retrieval information, to cause the first serving end to perform image processing based on the target parameter.

In this embodiment, the text descriptive information may be understood as image descriptive information corresponding to the image to be used and the descriptive information is in text form. The text descriptive information corresponds to image content of the image to be used, i.e., the text descriptive information may at least include information describing the image content of the corresponding image to be used in a visualized manner. The first serving end may be appreciated as a program for executing the image processing procedure. The first serving end may be a cloud service and also may be a local server.

In this embodiment, the target parameter may be appreciated as parameters in a target format. The parameters may be provided for requesting the first serving end to execute a corresponding task. The target format corresponding to the target parameter may be of any formats, and optionally may be JSON format.

In practical use, after the retrieval information corresponding to the respective images to be used is determined at the rendering end, the retrieval information and the corresponding text descriptive information may be processed based on the rendering end and the parameter including at least one retrieval information and the corresponding text descriptive information resulted from the processing serves as the target parameter.

Optionally, obtaining the target parameter to be sent to the first serving end by processing the text descriptive information of the image to be used and the retrieval information includes: obtaining the target parameter to be sent to the first serving end by concatenating the retrieval information of the image to be used and the corresponding text descriptive information.

In practical use, after the retrieval information of the at least one image to be used is determined, the retrieval information of the image to be used and the corresponding text information may be concatenated based on the rendering end and the parameter resulted from the concatenating acts as the target parameter to be sent to the first serving end.

It is to be explained that in order to splice the retrieval information with the corresponding text descriptive information at the time of concatenating, after the at least one image to be used is obtained, the text descriptive information corresponding to the image content of the image to be used may be determined and the text descriptive information is associated with the image to be used.

It is to be explained that there may be one or more images to be used, and the number of the retrieval information may correspondingly be one or more. In case of different numbers of retrieval information, the concatenating with the corresponding text descriptive information may vary. The two scenarios are respectively explained below.

In a first scenario where there is one retrieval information, after the rendering end receives the retrieval information, the corresponding image to be used may be determined based on the retrieval information and the text descriptive information corresponding to the retrieval information is determined according to a predetermined association between the image to be used and the text descriptive information. Further, the retrieval information is concatenated with the text descriptive information to obtain the target parameter.

In a second scenario where there are at least two retrieval information, a set corresponding to the at least two retrieval information is determined and the set is fed back to the rendering end; the set is received based on the rendering end, and the text descriptive information is concatenated with the corresponding retrieval information in the set according to a predetermined association between the image to be used and the text descriptive information.

In this embodiment, on the condition that there are at least two retrieval information, an information set may be constructed based on at least two uniform identifiers and the set is considered as the set corresponding to the at least two retrieval information.

In practical use, in case that there are at least two retrieval information, a set corresponding to at least two retrieval information may be determined and the set is fed back to the rendering end. Further, where the set is received at the rendering end, for respective retrieval information included in the set, the image to be used corresponding to the current retrieval information may be determined. Moreover, the text descriptive information corresponding to the current retrieval information may be determined according to a predetermined association between the image to be used and the text descriptive information. The text descriptive information corresponding to the respective retrieval information in the set may be determined. Furthermore, the respective retrieval information may be concatenated with the corresponding text descriptive information according to a target format, so as to obtain the target parameter including the at least two retrieval information and the corresponding text descriptive information. The above setting achieves the effect of concatenating the text descriptive information with the corresponding retrieval information in case of a plurality of retrieval information. This further enhances the matching degree between the retrieval information and the text descriptive information.

The technical solution according to the embodiments of the present disclosure determines retrieval information corresponding to at least one image to be used; and further obtains a target parameter to be sent to a first serving end by processing text descriptive information of the image to be used and the retrieval information, to cause the first serving end to perform image processing based on the target parameter. As a result, the technical solution solves the problem of image transfer delay or image transfer failure caused by an excessively high portion of the processing memory occupied or a relatively high demand for the bandwidth of the serving end during image processing in the related art. With the technical solution, the parameter to be sent to the serving end is determined based on the retrieval information and the image descriptive information corresponding to the image, the data transfer efficiency is improved and the respective associated executive subjects are decoupled during the image processing, such that each executive subject has a more dedicated function. The image processing efficiency is therefore enhanced.

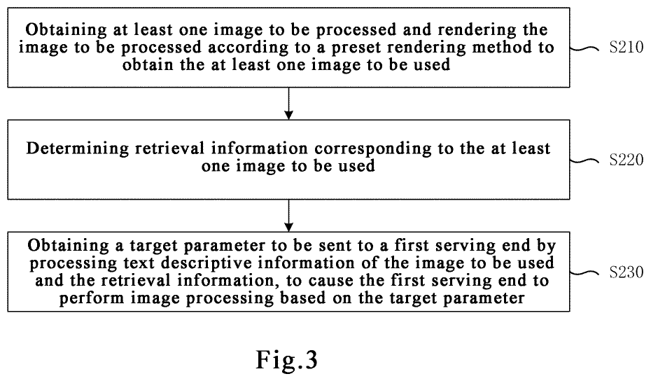

FIG. 3 illustrates a schematic flowchart of a further image processing method provided by embodiments of the present disclosure. On the basis of the above embodiments, the technical solution of this embodiment can determine at least one image to be used before determining the retrieval information corresponding to the image to be used. Detailed implementations are provided in the explanation of this embodiment, wherein same or similar technical features in the above embodiments are not repeated here.

As shown in FIG. 3, the method of this embodiment specifically includes:

S210: obtaining at least one image to be processed and rendering the image to be processed according to a preset rendering method to obtain the at least one image to be used.

In this embodiment, the image to be processed may be appreciated as an image which is to be processed. Optionally, the image to be processed may be a default template image, and also may be an image collected based on a camera apparatus deployed on the client. Moreover, the image to be processed may be an image obtained from a target storage space (e.g., local terminal album etc.) in response to a triggering operation by the users, and also may be a received image uploaded by an external device etc. It is to be explained that the image to be processed may include a display object, where the display object may be appreciated as an object to be rendered. The display object may be an object of any types as long as it can be displayed in the image. Optionally, the display object may include figures, animals or buildings etc. Correspondingly, the image to be used may correspond to at least one target part of the display object in the image to be processed. The target part may be any part of the display object displayed in the image, and optionally may be eyes, mouth or ear etc. A preset rendering method may be any image rendering method. Optionally, the preset rendering method may be a rendering method for obtaining a preset region image in the image or an image stylized rendering method etc.

In practical use, when the client obtains the image to be processed, the image to be processed may be sent to the rendering end. Further, after the rendering end receives the image to be processed, the image to be processed may be rendered based on the preset rendering method, so as to obtain at least one image to be used corresponding to the image to be processed and store each image to be used at the rendering end.

As an example, it is assumed that the preset rendering method is a rendering method for obtaining the preset region image in the image and the display object included in the image to be processed is a dog. The image to be processed is rendered according to the preset rendering method to cut out dog eyes, dog mouth and dog ear displayed in the image to be processed from the image to be processed. Accordingly, the image to be used including the dog eyes, the image to be used including the dog mouth and the image to be used including dog ear are obtained.

It is to be explained that the at least one image to be used, after being obtained, may be stored at the rendering end. When the image to be used is stored at the rendering end, a storage address may be determined based on the storage position of the image to be used and the storage address may serve as a local storage address of the image to be used. The local storage address may be used to characterize the storage position of the image to be used in the rendering end.

In practical use, in case that the image to be used is stored at the rendering end, the local storage address corresponding to each image to be used is determined. Furthermore, the local storage address of the image to be used may be sent to the client, to allow the client to read the image to be used from the rendering end based on the local storage address.

It is also explained that on the basis of the above respective technical solutions, the method further comprises: determining text descriptive information corresponding to the at least one image to be processed and associating the text descriptive information with the at least one image to be used.

In this embodiment, after at least one image to be used corresponding to the image to be processed is determined based on the rendering end, the image content of the image to be processed may also be analyzed based on the rendering end, so as to determine the text descriptive information corresponding to the image to be processed, wherein the text descriptive information corresponding to the image to be processed may be information that visually describes the overall image content of the image to be processed. As an example, assuming that the image to be processed includes three display objects, the corresponding text descriptive information may be information that holistically describes the three display objects. Alternatively, where the image to be processed includes at least two display objects, the text descriptive information corresponding to the image to be processed may be the information that describes each display object separately. As an example, continuing to refer to above example, assuming that the image to be processed includes three display objects, the corresponding text descriptive information may be information resulted from respective visualized description of the three display objects. The text descriptive information corresponding to each display object is thus obtained. Optionally, in case that the image to be processed includes a display object, the text descriptive information may correspond to the descriptive information of the display object in at least one reference dimension. The at least one reference dimension may include at least one of dimension of object category, dimension of object maturity, dimension of total quantity of object and dimension of the quantity of a single object under different object categories. The dimension of object category may be understood as the category to which the display object belongs. Optionally, the dimension of object category may include animals, figures or buildings etc. The dimension of object maturity may be provided to indicate the degree of maturity of the display object. The dimension of total quantity of object may indicate the total number of the display objects in a corresponding image to be processed. The dimension of the quantity of a single object under different object categories may be understood as the number of objects corresponding to each object category.

In practical use, when at least one image to be processed is received based on the rendering end, the image content of the at least one image to be processed may be analyzed, i.e., the text descriptive information corresponding to the at least one image to be processed is obtained. Furthermore, after at least one image to be used corresponding to the image to be processed is obtained, the text descriptive information corresponding to the image to be processed may be associated with the corresponding image to be used.

S220: determining retrieval information corresponding to at least one image to be used.

S230: obtaining a target parameter to be sent to a first serving end by processing text descriptive information of the image to be used and the retrieval information, to cause the first serving end to perform image processing based on the target parameter.

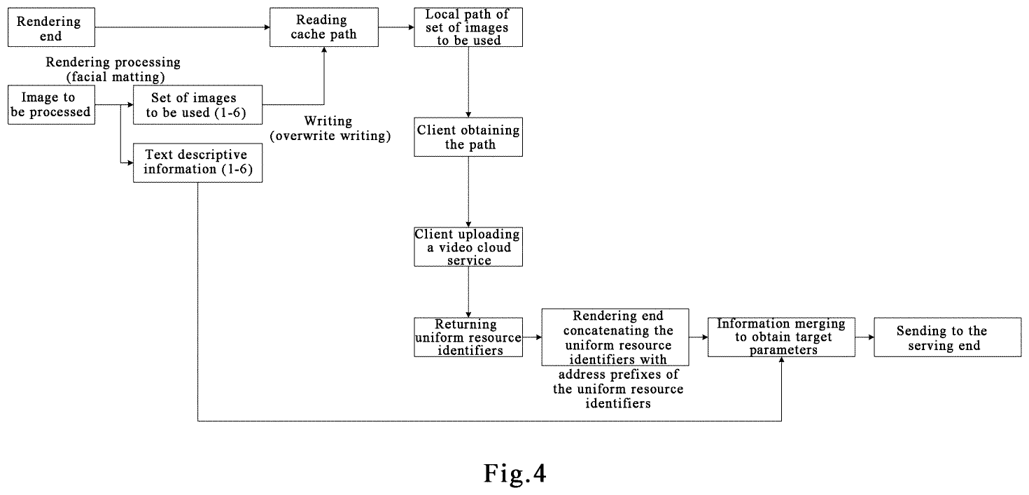

As an example, FIG. 4 illustrates a schematic flowchart of an image processing method provided by embodiments of the present disclosure. As shown in FIG. 4, the image to be processed sent by the client is received based on the rendering end and a face matting is performed on the image to be processed, to obtain a set of images to be used including the at least one image to be used and the text descriptive information of the image to be processed. Moreover, the set of images to be used may be locally stored to obtain a local storage path of the set of images to be used and the local storage path is sent to the client. Afterwards, the client receives the local storage path and obtains the set of images to be used according to the local storage path. Furthermore, the set of images to be used may be sent to the video cloud service and a set of uniform resource identifiers corresponding to the set of images to be used is determined. Subsequently, the set of uniform resource identifiers may be sent to the rendering end, to enable the rendering end to splice the text descriptive information with at least one uniform resource identifier in the set of uniform resource identifiers, thereby obtaining the target parameters to be sent to the serving end.

The technical solution according to the embodiments of the present disclosure obtains at least one image to be processed and renders the image to be processed according to a preset rendering method to obtain the at least one image to be used. Further, the technical solution determines retrieval information corresponding to at least one image to be used and finally obtains a target parameter to be sent to a first serving end by processing text descriptive information of the image to be used and the retrieval information, to cause the first serving end to perform image processing based on the target parameter. Accordingly, the technical solution achieves the effects of determining the text descriptive information corresponding to the image while rendering the images based on the rendering end, further determining the target parameter based on the text descriptive information. As a result, the serving end can more efficiently and accurately determine the target image based on the target parameter.

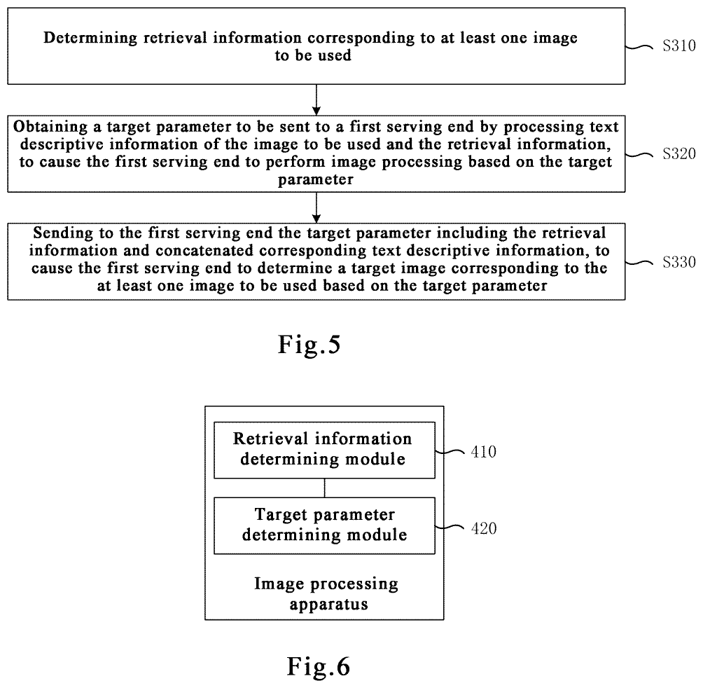

FIG. 5 illustrates a schematic flowchart of a further image processing method provided by an embodiment of the present disclosure. On the basis of the above embodiments, the technical solution of this embodiment, after the target parameter is obtained, may send to the first serving end a target parameter, such that the first serving end determines a target image corresponding to the at least one image to be used based on the target parameter. The detailed implementations may refer to the explanation of this embodiment, wherein the same or similar technical effects already disclosed in the preceding embodiments will not be repeated here.

As shown in FIG. 5, the method according to this embodiment may specifically include:

S310: determining retrieval information corresponding to at least one image to be used.

S320: obtaining a target parameter to be sent to a first serving end by processing text descriptive information of the image to be used and the retrieval information, to cause the first serving end to perform image processing based on the target parameter.

S330: sending to the first serving end the target parameter including the retrieval information and concatenated corresponding text descriptive information, to cause the first serving end to determine a target image corresponding to the at least one image to be used based on the target parameter.

In this embodiment, after the target parameter to be sent to the first serving end is obtained, the target parameter may be sent to the first serving end, to further facilitate the first serving end to determine the target image corresponding to the at least one image to be used based on the target parameter, wherein the target image may be understood as the image including the image content of the at least one image to be used and satisfying the image processing needs. The target image may be of any types. Optionally, the target image may be an image resulted from fusing the at least one image to be used with the template image, wherein the template image may be an image determined based on the text descriptive information in the target parameter.

Optionally, determining the target image corresponding to the at least one image to be used based on the target parameter includes: determining a target fusion image based on analysis processing by the first serving end on text descriptive information in the target parameter and fusion information of at least one fusion image to be selected; and obtaining the image to be used from a second serving end based on the retrieval information in the target parameter and fusing the image to be used into the target fusion image according to the fusion information of the target fusion image, so as to obtain the target image.

In this embodiment, the fusion image to be selected may be appreciated as a candidate fusion template image that can be applied into the image fusion operation. Optionally, the fusion image to be selected may be an image pre-stored in the serving end, and also may be an image received by the serving end from the external device etc. In general, the image fusion refers to fusing an image including at least one target part to a fusion base image consisting of the complete image information. Therefore, where the image to be used corresponds to at least one target part of the display object in the image to be processed, the fusion image to be selected may include an object to be fused. The fusion information may be appreciated as information that can be applied to image fusion operation in the image. The fusion information may include various information associated with the image fusion procedure. Optionally, the fusion information may include the descriptive information of the respective objects to be fused in at least one reference dimension in the fusion image to be selected and part key information of at least one target part of the object to be fused, wherein the descriptive information of the object to be fused in at least one reference dimension may be used to locate the target fusion image corresponding to the at least one image to be used. The fusion information may be provided for executing the image fusion operation. The target fusion image is an fusion image to be selected, which fusion image to be selected is selected from the at least one fusion image to be selected and has corresponding fusion information matching with the text descriptive information in the target parameter.

In practical use, after the first serving end receives the target parameter, the target parameter may be parsed based on the first serving end, to obtain the text descriptive information and at least one retrieval information in the target parameter. Afterwards, the at least one fusion image to be selected may be determined based on the first serving end and the fusion information corresponding to the respective fusion images to be selected is determined. Further, the text descriptive information and the fusion information corresponding to the respective fusion images to be selected may be analyzed to determine from the respective fusion information the fusion information conforming to the text descriptive information and regard the fusion image to be selected corresponding to the fusion information as the target fusion image. Moreover, after at least one retrieval information in the target parameter is obtained, respective images to be used may be obtained from the second serving end based on the retrieval information. After the target fusion image is determined, image fusion position and image fusion angle of the image to be used may be determined based on the fusion information of the target fusion image. Accordingly, the image to be used may be fused to the target fusion image based on the determined image fusion position and image fusion angle, i.e., the target image is obtained; wherein the image fusion position may be determined based on the descriptive information of the objects to be fused in at least one reference dimension in the fusion information; and the image fusion angle may be determined based on the part key information of the at least one target part of the object to be fused included in the fusion information. With such setting, the image fusion procedure executed by the serving end based on the target parameter produces better effects, the pressure on the bandwidth of the serving end is lowered and the efficiency and success rate of image processing are increased.

As an example, it is assumed that the image to be processed includes four display objects, the number of the images to be processed is four, and each image to be used includes a facial part of one display object. Correspondingly, the text descriptive information is: the total number of objects is four, including two users of gender A, one user of gender B and a dog. One the two users of gender A has an object maturity of 25-30 while the other has an object maturity of 5-10. The object maturity of the user of gender B is 15-20. Assuming that the serving end includes three fusion images to be selected, respectively being fusion image 1 to be selected, fusion image 2 to be selected and fusion image 3 to be selected, the fusion information for the fusion image 1 to be selected is: the total number of objects is three, including one user of gender A, one user of gender B and one cat. The object maturity of the user of gender A is 10-15 and the object maturity of the user of gender B is 20-25. The fusion information of the fusion image 2 to be selected is: the total number of objects is four, including two users of gender A, one user of gender B and a dog. One of the two users of gender A has an object maturity of 25-30, and the other user has an object maturity of 5-10. The object maturity for the user of gender B is 15-20. Meanwhile, the fusion information also includes the part key information of the facial part of respective objects. The fusion information of the fusion image 3 to be selected is: the total number of objects is one. The object category of the object is a user of gender B and the object maturity is 25-30. According to the analysis processing on the text descriptive information and the fusion information of the above three fusion images to be selected, the determined target fusion image is the fusion image 2 to be selected. Furthermore, the image fusion positions and the image fusion angles of the four images to be used on the fusion image 2 to be selected may be determined respectively based on the fusion information of the fusion image 2 to be selected, so as to update the facial part of respective objects included in the fusion image 2 to be selected to be the facial part of respective objects included in the image to be processed. Moreover, the fusion image 2 to be selected after the facial part update may serve as the target image.

In order to display the target image to allow the users to clearly see the display effects of the target image, the target image, after being obtained, may also be sent to the client based on the first serving end, so as to display the target image on the client.

To ensure that the images transferred among the client, the rendering end, the video serving end and the serving end conform to a preset review standard, an image review end may be configured, so as to process the image based on the image review end after receipt of the image and intercept images that do not meet the preset review standard. In practical use, before the target image is generated based on the serving end, the image to be processed and/or the image to be used may be reviewed. This review may be considered as a pre-review. Furthermore, after the target image is determined based on the serving end, the target image may also be reviewed to avoid that the generated image does not meet the preset review standard. This review may be regarded as a post-review.

On the basis of the above respective technical solutions, the method further comprises: performing feature extraction on an image to be processed, an image to be used and/or a target image to obtain a feature to be processed; in case that the feature to be processed matches with at least one preset feature in a set of preset features, not processing the image to be processed and/or the image to be used and not displaying the target image.

Wherein the feature to be processed may be understood as information for characterizing image key features. The set of preset features may include a plurality of sets of preset features. The preset feature may be predetermined and also may be features appearing in the images involved in the image processing. The preset feature may include various types of features. Optionally, the preset feature may include part feature information of at least one target part of the preset object or scenario feature information corresponding to the preset scenario etc.

In practical use, for the image to be processed, the image to be used and/or the target image, after the image to be processed is obtained, a feature extraction may be performed on the image to be processed, to obtain the feature to be processed corresponding to the image to be processed. Furthermore, the preset features may match with the set of preset features. When the feature to be processed matches with at least one preset feature in the set of preset features, the image to be processed may not be processed. After the image to be used is obtained, the feature extraction may be performed on the image to be used, to obtain the feature to be processed corresponding to the image to be used. Moreover, the feature to be processed may match with the set of preset features. When the feature to be processed matches with at least one preset feature in the set of preset features, the image to be used may not be processed. After the target image is obtained, the feature extraction may be performed on the target image to obtain the feature to be processed corresponding to the target image. Further, the feature to be processed may match with the set of preset features. When the feature to be processed matches with at least one preset feature in the set of preset features, the target image may not be displayed. With such setting, images not conforming to the review requirements during the image processing may be intercepted. This ensures safety of the image processing procedure and further enhances intelligent performance of interception during the image processing.

It is to be explained that the feature to be processed may be the feature included in the corresponding image incompatible with the review standard. In case that the image to be processed, the image to be used and/or the target image all include the target part, the image may be intercepted by determining whether the target part included in each image conforms to the preset review standard. Optionally, the feature extraction is performed on the target part of the image to be processed, the image to be used and/or the target image, so as to obtain the feature to be processed, wherein the target part may be any part and optionally may be a facial part.

The technical solution according to the embodiments of the present disclosure determines retrieval information corresponding to at least one image to be used and further obtains a target parameter to be sent to a first serving end by processing text descriptive information of the image to be used and the retrieval information, to cause the first serving end to perform image processing based on the target parameter. In the end, the technical solution sends to the first serving end a target parameter including retrieval information and concatenating of corresponding text descriptive information, such that the first serving end determines a target image corresponding to the at least one image to be used based on the target parameter. Therefore, the serving end can execute the image fusion procedure based on the target parameters, which lowers the pressure on the bandwidth of the serving end and improves efficiency and success rate of the image processing.

FIG. 6 illustrates a structural diagram of an image processing apparatus provided by this embodiment of the present disclosure. As shown in FIG. 6, the apparatus comprises: a retrieval information determining module 410 and a target parameter determining module 420.

Wherein the retrieval information determining module 410 is provided for determining retrieval information corresponding to at least one image to be used; and the target parameter determining module is used for obtaining a target parameter to be sent to a first serving end by processing text descriptive information of the image to be used and the retrieval information, to cause the first serving end to perform image processing based on the target parameter; wherein the text descriptive information corresponds to image content of the image to be used.

On the basis of the above respective alternative technical solutions, optionally, the apparatus also comprises: an image rendering module.

The image rendering module is provided for obtaining at least one image to be processed and rendering the image to be processed according to a preset rendering method to obtain the at least one image to be used.

On the basis of the above respective alternative technical solutions, optionally, the apparatus also comprises: a descriptive information determining module.

The descriptive information determining module is used for determining text descriptive information corresponding to the at least one image to be processed and associating the text descriptive information with the at least one image to be used.

On the basis of the above respective alternative technical solutions, optionally, the at least one image to be used includes at least two images to be used and the retrieval information determining module 410 includes: an image uploading unit and a retrieval information determining unit.

The image uploading unit is provided for uploading the at least two images to be used to a second serving end and recording an uploading order of the at least two images to be used;

The retrieval information determining unit is used for determining, based on the uploading order and a receiving order by which the second serving end receives the at least two images to be used, retrieval information corresponding to the at least two images to be used.

On the basis of the above respective alternative technical solutions, optionally, the target parameter determining module 420 is specifically used for obtaining the target parameter to be sent to the first serving end by concatenating the retrieval information of the image to be used and the corresponding text descriptive information.

On the basis of the above respective alternative technical solutions, optionally, the apparatus also comprises: an image determining module.

The image determining module is provided for, after the target parameter is obtained, sending to the first serving end the target parameter including the retrieval information and concatenated corresponding text descriptive information, cause the first serving end to determine a target image corresponding to the at least one image to be used based on the target parameter.

On the basis of the above respective alternative technical solutions, optionally, the image determining module includes: a fusion image determining unit and a target image determining unit.

The fusion image determining unit is used for determining a target fusion image based on analysis processing by the first serving end on text descriptive information in the target parameter and fusion information of at least one fusion image to be selected; and

The target image determining unit is used for obtaining the image to be used from a second serving end based on the retrieval information in the target parameter and fusing the image to be used into the target fusion image according to the fusion information of the target fusion image, so as to obtain the target image.

On the basis of the above respective alternative technical solutions, optionally, the retrieval information includes a uniform resource identifier of the image to be used.

On the basis of the above respective alternative technical solutions, optionally, the apparatus also comprises: a feature extracting module and a feature matching module.

The feature extracting module is used for performing feature extraction on an image to be processed, an image to be used and/or a target image to obtain a feature to be processed;

The feature matching module is provided for, in case that the feature to be processed matches with at least one preset feature in a set of preset features, not processing the image to be processed and/or the image to be used and not displaying the target image.

The technical solution according to the embodiments of the present disclosure determines retrieval information corresponding to at least one image to be used; and further obtains a target parameter to be sent to a first serving end by processing text descriptive information of the image to be used and the retrieval information, to cause the first serving end to perform image processing based on the target parameter. As a result, the technical solution solves the problem of image transfer delay or image transfer failure caused by an excessively high portion of the processing memory occupied or a relatively high demand for the bandwidth of the serving end during image processing in the related art. With the technical solution, the parameter to be sent to the serving end is determined based on the retrieval information and the image descriptive information corresponding to the image, the data transfer efficiency is improved and the respective associated executive subjects are decoupled during the image processing, such that each executive subject has a more dedicated function. The image processing efficiency is therefore enhanced.

The image processing apparatus provided by the embodiments of the present disclosure can execute the image processing method according to any embodiments of the present disclosure. The apparatus includes corresponding functional modules for executing the method and achieves advantageous effects.

It is to be noteworthy that the respective units and modules included in the above apparatus are divided only by functional logic. The units and modules may also be divided in other ways as long as they can fulfill the corresponding functions. Further, the names of the respective functional units are provided only to distinguish one from another, rather than restricting the protection scope of the embodiments of the present disclosure.

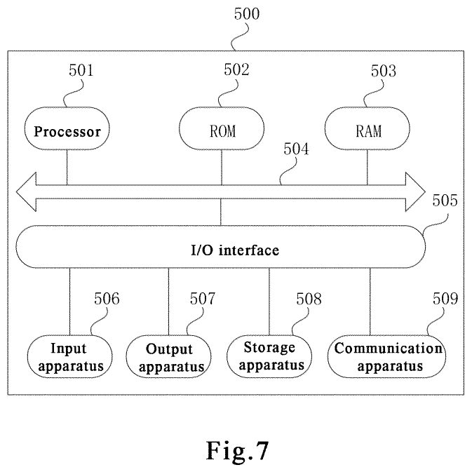

FIG. 7 illustrates a structural diagram of an electronic device provided by the embodiments of the present disclosure. With reference to FIG. 7, a structural diagram of an electronic device (e.g., terminal device or server in FIG. 7) 500 adapted to implement embodiments of the present disclosure is shown. In the embodiments of the present disclosure, the terminal device may include, but not limited to, mobile terminals, such as mobile phones, notebooks, digital broadcast receivers, PDAs (Personal Digital Assistant), PADs (tablet computer), PMPs (Portable Multimedia Player) and vehicle terminals (such as car navigation terminal) and fixed terminals, e.g., digital TVs and desktop computers etc. The electronic device shown in FIG. 7 is just an example and will not restrict the functions and application ranges of the embodiments of the present disclosure.

According to FIG. 7, the electronic device 500 may include a processing apparatus (e.g., central processor, graphic processor and the like) 501, which can execute various suitable actions and processing based on the programs stored in the read-only memory (ROM) 502 or programs loaded in the random-access memory (RAM) 503 from a storage apparatus 508. The RAM 503 can also store all kinds of programs and data required by the operations of the electronic device 500. Processing apparatus 501, ROM 502 and RAM 503 are connected to each other via a bus 504. The input/output (I/O) interface 505 is also connected to the bus 504.

Usually, input apparatus 506 (including touch screen, touchpad, keyboard, mouse, camera, microphone, accelerometer, gyroscope and like) and output apparatus 507 (including liquid crystal display (LCD), speaker and vibrator etc.), storage apparatus 508 (including tape and hard disk etc.) and communication apparatus 509 may be connected to the I/O interface 505. The communication apparatus 509 may allow the electronic device 500 to exchange data with other devices through wired or wireless communications. Although FIG. 7 illustrates the electronic device 500 having various units, it is to be understood that it is not a prerequisite to implement or provide all illustrated units. Alternatively, more or less units may be implemented or provided.

In particular, according to embodiments of the present disclosure, the process depicted above with reference to the flowchart may be implemented as computer software programs. For example, the embodiments of the present disclosure include a computer program product including computer programs carried on a non-transient computer readable medium, wherein the computer programs include program codes for executing the method demonstrated by the flowchart. In these embodiments, the computer programs may be loaded and installed from networks via the communication apparatus 509, or installed from the storage apparatus 508, or installed from the ROM 502. The computer programs, when executed by the processing apparatus 501, performs the above functions defined in the method for video editing according to the embodiments of the present disclosure.

Names of the messages or information exchanged between a plurality of apparatuses in the implementations of the present disclosure are provided only for explanatory purpose, rather than restricting the scope of the messages or information.

The electronic device provided by the embodiments of the present disclosure and the image processing method according to the above embodiments belong to the same inventive concept. The technical details not elaborated in these embodiments may refer to the above embodiments. Besides, these embodiments and the above embodiments achieve the same advantageous effects.

Embodiments of the present disclosure provide a computer storage medium on which computer programs are stored, which programs when executed by a processor implement the image processing method provided by the above embodiments.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (Hyper Text Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device. The above computer readable medium bears one or more programs. When the above one or more programs are executed by the electronic device, the electronic device is enabled to: determine retrieval information corresponding to at least one image to be used; obtain a target parameter to be sent to a first serving end by processing text descriptive information of the image to be used and the retrieval information, to cause the first serving end to perform image processing based on the target parameter; wherein the text descriptive information corresponds to image content of the image to be used.

Computer program instructions for executing operations of the present disclosure may be written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, a first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/we claim:

1. An image processing method, comprising:
determining retrieval information corresponding to at least one image to be used; and
obtaining a target parameter to be sent to a first serving end by processing text descriptive information of the image to be used and the retrieval information, to cause the first serving end to perform image processing based on the target parameter;
wherein the text descriptive information corresponds to image content of the image to be used.

2. The method of claim 1, further comprising:
obtaining at least one image to be processed and rendering the image to be processed according to a preset rendering method to obtain the at least one image to be used.

3. The method of claim 2, further comprising:
determining text descriptive information corresponding to the at least one image to be processed and associating the text descriptive information with the at least one image to be used.

4. The method of claim 1, wherein the at least one image to be used includes at least two images to be used, and determining the retrieval information corresponding to the at least one image to be used includes:
uploading the at least two images to be used to a second serving end and recording an uploading order of the at least two images to be used; and
determining, based on the uploading order and a receiving order by which the second serving end receives the at least two images to be used, retrieval information corresponding to the at least two images to be used.

5. The method of claim 1, wherein obtaining the target parameter to be sent to the first serving end by processing the text descriptive information of the image to be used and the retrieval information includes:
obtaining the target parameter to be sent to the first serving end by concatenating the retrieval information of the image to be used and the corresponding text descriptive information.

6. The method of claim 1, wherein the method further comprises, after the target parameter is obtained:
sending to the first serving end the target parameter including the retrieval information and concatenated corresponding text descriptive information, to cause the first serving end to determine a target image corresponding to the at least one image to be used based on the target parameter.

7. The method of claim 6, wherein determining the target image corresponding to the at least one image to be used based on the target parameter includes:
determining a target fusion image based on analysis processing by the first serving end on the text descriptive information in the target parameter and fusion information of at least one fusion image to be selected; and
obtaining the image to be used from a second serving end based on the retrieval information in the target parameter and fusing the image to be used into the target fusion image according to the fusion information of the target fusion image, so as to obtain the target image.

8. The method of claim 1, wherein the retrieval information includes a uniform resource identifier of the image to be used.

9. The method of claim 1, further comprising:
performing feature extraction on an image to be processed, the image to be used and/or a target image to obtain a feature to be processed; and
in case that the feature to be processed matches with at least one preset feature in a set of preset features, not processing the image to be processed and/or the image to be used and not displaying the target image.

10. An electronic device, comprising:
one or more processors; and
a storage apparatus for storing one or more programs;
the one or more programs, when executed by the one or more processors, causing the one or more processors to implement an image processing method comprising:
determining retrieval information corresponding to at least one image to be used; and
obtaining a target parameter to be sent to a first serving end by processing text descriptive information of the image to be used and the retrieval information, to cause the first serving end to perform image processing based on the target parameter;
wherein the text descriptive information corresponds to image content of the image to be used.

11. The electronic device of claim 10, wherein the method further comprises:
obtaining at least one image to be processed and rendering the image to be processed according to a preset rendering method to obtain the at least one image to be used.

12. The electronic device of claim 11, wherein the method further comprises:
determining text descriptive information corresponding to the at least one image to be processed and associating the text descriptive information with the at least one image to be used.

13. The electronic device of claim 10, wherein the at least one image to be used includes at least two images to be used, and determining the retrieval information corresponding to the at least one image to be used includes:
uploading the at least two images to be used to a second serving end and recording an uploading order of the at least two images to be used; and
determining, based on the uploading order and a receiving order by which the second serving end receives the at least two images to be used, retrieval information corresponding to the at least two images to be used.

14. The electronic device of claim 10, wherein obtaining the target parameter to be sent to the first serving end by processing the text descriptive information of the image to be used and the retrieval information includes:
obtaining the target parameter to be sent to the first serving end by concatenating the retrieval information of the image to be used and the corresponding text descriptive information.

15. The electronic device of claim 10, wherein the method further comprises, after the target parameter is obtained:
sending to the first serving end the target parameter including the retrieval information and concatenated corresponding text descriptive information, to cause the first serving end to determine a target image corresponding to the at least one image to be used based on the target parameter.

16. The electronic device of claim 15, wherein determining the target image corresponding to the at least one image to be used based on the target parameter includes:
determining a target fusion image based on analysis processing by the first serving end on the text descriptive information in the target parameter and fusion information of at least one fusion image to be selected; and
obtaining the image to be used from a second serving end based on the retrieval information in the target parameter and fusing the image to be used into the target fusion image according to the fusion information of the target fusion image, so as to obtain the target image.

17. The electronic device of claim 10, wherein the retrieval information includes a uniform resource identifier of the image to be used.

18. The electronic device of claim 10, wherein the method further comprises:
performing feature extraction on an image to be processed, the image to be used and/or a target image to obtain a feature to be processed; and
in case that the feature to be processed matches with at least one preset feature in a set of preset features, not processing the image to be processed and/or the image to be used and not displaying the target image.

19. A non-transitory storage medium containing computer-executable instructions, wherein the computer-executable instructions, when executed by a computer processor, perform an image processing method comprising:
determining retrieval information corresponding to at least one image to be used; and
obtaining a target parameter to be sent to a first serving end by processing text descriptive information of the image to be used and the retrieval information, to cause the first serving end to perform image processing based on the target parameter;
wherein the text descriptive information corresponds to image content of the image to be used.

20. The non-transitory storage medium of claim 19, wherein the method further comprises:
obtaining at least one image to be processed and rendering the image to be processed according to a preset rendering method to obtain the at least one image to be used.
